(19) United States
(12) Patent Application Publication
(10) Pub. No.: US 2010/0074802 A1
(43) Pub. Date: Mar. 25, 2010

(54) MICROVOLUME LIQUID DISPENSING DEVICE

(76) Inventor: Takashi Yasuda, Fukuoka (JP)

Correspondence Address: KUBOVCIK & KUBOVCIK, SUITE 1105, 1215 SOUTH CLARK STREET, ARLINGTON, VA, 22202, US

(21) Appl. No.: 12/312,754

(22) PCT Filed: Nov. 27, 2007
(86) PCT No.: PCT/JP2007/072868

§ 371 Date: May 26, 2009

(30) Foreign Application Priority Data
Nov. 27, 2006 (JP) 2006-318948

(51) Int. Cl. B01L 3/02

(52) U.S. Cl. 422/100

(57) ABSTRACT

A microvolume liquid dispensing device capable of automatically dispensing a predetermined volume of a microvolume liquid placed from the outside. Because one surface of a main flow path (13) is gradually varied from a hydrophobic nature to a hydrophilic nature, a microvolume liquid (A) placed in the main flow path (13) can be automatically conveyed. One surface of a side flow path (14) is of a hydrophilic nature, so that a portion of the microvolume liquid (A) can be automatically dispensed to the side flow path (14).

### TECHNICAL FIELD

The present invention belongs to the technical field of handling a microvolume liquid within a microfluidic device, and in particular, relates to an art of measuring and mixing a specific amount of a microvolume liquid in a simple and easy way.

### BACKGROUND ART

In the drug discovery field of developing a new drug, a compound that could be a new drug is searched comprehensively from hundreds of thousands to millions of kinds of new drug candidate compounds. Thereafter, operations of changing the concentration of the compound into various values and deriving an appropriate concentration are carried out. In the conventional art an automatic liquid dispensing device is used, and an operation of dispensing a liquid which contains a new drug candidate compound on a micro plate by using a multichannel pipette is carried out. In this method, enormous costs are required since a large amount of an expensive agent is used and the device itself is large and expensive. Consequently, an art of microminiaturizing such an automatic liquid dispensing device has recently been developed. If the microminiaturization is realized, an amount of an agent used is significantly reduced and the entire device becomes compact and inexpensive. As a result, costs required for drug discovery can remarkably be reduced.

On the other hand, research and development of fabricating a microchannel on a substrate such as of silicon and glass and performing a variety of analyses with the use of the micro space has actively been carried out recently. This has received attention as an art capable of promoting speedups in analyses, reductions in amounts of reagents used and waste liquids, on-site analyzation, integration of different kinds of analyses, etc. Inventions as described in Patent Documents 1 to 4, for example, have succeeded in measuring a liquid in a channel having a specific volume and generating a droplet, or preparing liquid mixtures having various mixing ratios. Those inventions are considered applicable to the aforementioned drug discovery field.

Patent. Document 1: Japanese Published Unexamined Patent Application No. 2002-357616

Patent Document 2: Japanese Published Unexamined Patent Application No. 2004-157097

Patent Document 3: Japanese Published Unexamined Patent Application No. 2005-114430

Patent Document 4: Japanese Patent No. 3749991

### DISCLOSURE OF THE INVENTION

### Problems to be Solved by the Invention

In the inventions as described in Patent Documents 1 to 4, however, the channel of the device and its peripheral equipment need to be connected by a tube for pressure operation of the microvolume liquid when a development test of a new drug is carried out. Therefore, the operation in use is complicated, and also a large amount of the reagent remaining in the tube, etc., is wasted.

An object of the present invention is to provide a microvolume liquid dispensing device capable of automatically sampling a predetermined amount of a microvolume liquid having been injected from the outside.

Another object of the present invention is to provide a microvolume liquid dispensing device capable of transporting a microvolume liquid to the downstream of a side channel by voltage application.

Still another object of the present invention is to provide a microvolume liquid dispensing device capable of mixing a plurality of microvolume liquids by voltage application.

Still another object of the present invention is to provide a microvolume liquid dispensing device capable of mixing different kinds of microvolume liquids at different mixing ratios.

Still another object of the present invention is to provide a microvolume liquid dispensing device which easily guides a microvolume liquid being transported in a main channel into a side channel.

Still another object of the present invention is to provide a microvolume liquid dispensing device capable of easily taking out a microvolume liquid in a side channel to the outside.

### Means for Solving the Problems

The invention as set forth in claim 1 is a microvolume liquid dispensing device including a substrate, a cover mounted on one surface of the substrate, a main channel formed between the substrate and the cover and extending substantially linearly, and one or a plurality of side channels formed between the substrate and the cover, branched off from midway of the main channel and extending substantially linearly, wherein at least one surface of inner wall surfaces constituting the main channel is composed of a hydrophilic surface and a hydrophobic surface, a value obtained by dividing an area of the hydrophilic surface by that of the hydrophobic surface is continuously increased from upstream toward downstream thereof, thereby transporting a microvolume liquid, at least one surface of inner wall surfaces constituting the side channel is made hydrophilic, and a part of the microvolume liquid is guided to the side channel while the microvolume liquid is being transported in the main channel, thereby sampling a predetermined amount of the microvolume liquid.

Surface tension is such a force that a surface of a liquid or solid attempts to constrict itself and minimize its own area. When a microvolume liquid (a droplet) is placed on a solid surface, three of liquid surface tension, solid surface tension and interfacial tension acting upon an interface between a liquid and a solid are balanced, whereupon the liquid surface and the solid surface form a specific angle. Generally, a hydrophilic solid surface likely to conform to a liquid possesses a large surface tension. When placed on the solid surface, a liquid is pulled by the large surface tension of the solid surface and spread out. On the other hand, a hydrophobic solid surface difficult to conform to a liquid possesses a small surface tension. When placed on the solid surface, a liquid is not spread out and becomes hemispheric since the force pulled by the solid surface is small.

Taking advantage of those properties, at least one surface of the main channel is composed of a hydrophilic surface and a hydrophobic surface, and thereafter is formed on the substrate. The main channel is provided with a droplet transportation means transporting a microvolume liquid in one direction. More specifically, the one surface is configured by providing a surface high in hydrophobic property at the upstream of the main channel and a surface high in hydrophilic property at the downstream of the main channel on the substrate. For example, the one surface is formed by combining hydrophobic surfaces and hydrophilic surfaces of a triangular pattern alternately. It is formed in such a manner that a value obtained by dividing an area of the hydrophilic surfaces of the triangular pattern by an area of the hydrophobic surfaces of the triangular pattern is continuously increased from upstream toward downstream.

Further, when the microvolume liquid being transported in the main channel reaches a branch portion with the side channel, a part thereof is guided to the side channel by a capillary force and then sampled. This is due to the following reasons; the main channel is composed of a surface including a hydrophilic surface and a hydrophobic surface and a surface of a hydrophobic surface only. Both surfaces are more difficult to conform to a microvolume liquid than a surface of a hydrophilic surface only. Therefore, if a side channel having at least one surface of a hydrophilic surface only is provided midway of the main channel, a part of the microvolume liquid enters the side channel which is more likely to conform to a liquid by a capillary force when the microvolume liquid approaches an entrance of the side channel in the middle of traveling in the main channel. At that moment, the microvolume liquid traveling in the main channel has a certain speed, so that a predetermined amount of the microvolume liquid determined by a volume of the side channel enters the side channel, and then the microvolume liquid having entered the side channel and the microvolume liquid continuing to travel in the main channel are completely separated.

As a result, from a microvolume liquid having been injected form the outside, the predetermined amount of a microvolume liquid can automatically be sampled without connecting the device channel and its peripheral equipment by a tube and operating a pressure of the microvolume liquid as in the conventional manner.

A plurality of main channels may be provided. Alternatively, a plurality of main channels may be integrated into one main channel midway. Alternatively, one main channel may be branched into a plurality of main channels midway. A cross-sectional shape of the main channel and side channel is optional. For example, a polygonal shape including a rectangular shape and a trapezoidal shape, a circular shape, an elliptical shape, a semicircular shape, etc., can be adopted. It is noted that in the case of the main channel and side channel having a circular shape or an elliptical shape in cross section, one surface or the other surface in both channels shall be referred to as a substrate side surface of the channels or a cover side surface of the channels.

The number of side channels to be formed is optional. It may be one, and may be two or three or more. The ratio of a cross-sectional area of the side channel relative to the main channel is optional. For example, letting a cross-sectional area of the main channel be 1, a cross-sectional area of the side channel is 0.01 to 0.5. Note that a capillary force of the side channel will become large if the side channel has a cross-sectional area orthogonal to the longitudinal direction smaller than the main channel.

The side channel may be formed on one of the side walls of the main channel, or may be formed on both side walls. When a plurality of side channels are formed, a formation interval of the side channels in the longitudinal direction of the main channel is optional. For example, they may be formed at a constant pitch or at any interval.

At least one surface (a forming wall of one surface) of the main channel is optional as long as it is a surface (a wall) constituting the main channel. For example, it may be a bottom surface (a forming wall of a bottom surface) of the main channel or a ceiling surface (a forming wall of a ceiling surface) of the main channel, or may be both. If configured such that the bottom surface and ceiling surface of the main channel are both composed of a hydrophilic surface and a hydrophobic surface and a value obtained by dividing an area of the hydrophilic surface by that of the hydrophobic surface is continuously increased from upstream toward downstream of the channel, transportability of the microvolume liquid in the main channel will be further increased.

At least one surface of the side channel is optional as long as it is a surface (a wall) constituting the side channel. For example, it may be a bottom surface (a forming wall of a bottom surface) of the side channel, a ceiling surface (a forming wall of a ceiling surface) of the side channel or a side surface (a forming wall of a side surface) of the side channel, or may be a plurality of surfaces among them.

A raw material for the hydrophobic surface constituting at least one surface, for example, the bottom surface (the forming wall of the bottom surface) of the main channel is optional. A raw material for the hydrophilic surface (as well as a raw material for the hydrophilic surface of the side channel) is also optional. The hydrophobic surface may be formed with fluorinated polymers, for example, a polymer obtained by diluting a cyclized perfluoro polymer (CPFP) with a perfluoro solvent (trade name: Cytop CTL-809M of ASAHI GLASS CO., LTD.). Alternatively, a self-assembled monolayer having a hydrophobic functional group, for example, 1-octadecanethiol may be formed on a patterned gold surface by dipping. Alternatively, aplastic surface possessing hydrophobic property such as a cycloolefin polymer may be used. The hydrophilic surface may be formed with SiO₂ (silicon dioxide), or a glass substrate surface may be used. Fluorinated polymers, gold and SiO₂ are formed on a surface of a silicon substrate, glass substrate, plastic substrate, etc., by semiconductor process such as photolithography.

A material for the substrate and the cover is optional, for example, plastic, silicon, glass, etc. As a plastic, a cycloolefin polymer, polystyrene, polymethylmethacrylate, polycarbonate, etc., can be adopted, for example.

A shape of the substrate and the cover in a plan view is optional. For example, it may be a triangle, a polygon of a tetragon or more, a circle, an ellipsis, etc., in a plan view. Further, the substrate and the cover may be a flat plate having a constant thickness or a plate having partially different thicknesses.

At least one surface of the substrate is optional as long as it is a surface constituting the substrate. For example, it may be a top surface (a forming wall of a top surface) of the substrate or a bottom surface (a forming wall of a bottom surface) of the substrate, or may be both.

A forming method of the main channel and side channel on the substrate is optional. The channel can be formed by etching of a silicon substrate or glass substrate, injection molding with plastic, nano-imprinting on a glass substrate or plastic substrate, etc., for example. Moreover, a channel wall may be formed on a silicon substrate or glass substrate with a resist material or silicone resin material to provide the channel. Nano-imprinting is a technique of pressing a stamper having been applied with a minute concavo-convex pattern against a resin thin film or film (bulk) transferred material, thereupon transferring the pattern of the stamper.

As the microvolume liquid, a liquid containing ions such as electrolytic solution (for example, KCl), physiological saline, culture solution, etc., and a liquid including no ions such as ultrapure water can be adopted.

The invention as set forth in claim 2 is the microvolume liquid dispensing device according to claim 1, wherein the substrate and the cover possess electrical insulation, at least one surface of the inner wall surfaces constituting the side channel is provided with a first electrode and a second electrode in this order toward downstream thereof being spaced apart, a surface of the second electrode is hydrophobic, and a microvolume liquid having been dammed at an end of the second electrode having the hydrophobic surface is transported downstream of the side channel by applying a voltage between both electrodes.

According to the invention as set forth in claim 2, a microvolume liquid having been guided to the side channel by a capillary force passes through the first electrode and is dammed at (an end of) the second electrode provided downstream of the first electrode. This is because a surface of the second electrode contacting with the microvolume liquid is hydrophobic. At that moment, the microvolume liquid contacts with the second electrode at a front end portion thereof, and contacts with the first electrode in such a manner as straddling the electrode. When a voltage is applied to both electrodes provided midway of the channel, the second electrode with which the microvolume liquid contacts at the front end portion thereof attracts the microvolume liquid, so that a contact angle of the microvolume liquid becomes small. That is, apparent surface wettability of the second electrode turns from hydrophobic property to hydrophilic property. As a result, the microvolume liquid gets on the surface of the second electrode and gets over the second electrode eventually, and a specific amount of the microvolume liquid can be transported further in the side channel. At this moment, a force of carrying the liquid further in the side channel is a capillary force. Accordingly, if configured to make a side channel width at the downstream side of the second electrode smaller than that of the upstream side, the liquid can be delivered without fail.

Further, it becomes possible to start transporting the microvolume liquid at the time of applying the voltage. Furthermore, it becomes possible to adjust timing of mixing with another microvolume liquid on the device and to start transporting a plurality of microvolume liquids simultaneously.

The substrate and the cover are optional as long as they are electrically insulating materials. Note that, when a silicon substrate which is an electrically non-insulating body is used, an insulating film such as SiO₂ needs to be formed on the surface in order to form an electrode on the substrate.

A material for the first electrode and the second electrode is optional. Gold, aluminum and copper are used, for example. Among them, gold is easily formed into a film by vacuum evaporation and patterned by a lift-off method. When gold is used, however, adhesiveness with the substrate is poor. Therefore, if a chromium thin film is sandwiched between the gold thin film electrode and the substrate, adhesiveness between the gold thin film electrode and the substrate will be enhanced. A method for achieving hydrophobic property on the surface of the second electrode is optional. Since a gold surface just after the film formation exhibits hydrophobic property, the surface may be used as it is. However, the hydrophobic property is lowered with time, and accordingly it is better to form a hydrophobic thin film on the surface. Conceivable methods include, for example, coating the surface with a fluorinated polymer such as Cytop manufactured by ASAHI GLASS CO., LTD., and forming a self-assembled monolayer having a hydrophobic functional group such as 1-octadecanethiol.

Both electrodes as described above may be an electrode with irregularities or inclination. However, a flat thin film electrode is preferred.

Where both electrodes are provided may be only on one surface of the side channel or may be on two or more surfaces of the side channel.

A film thickness of both electrodes is, for example, 0.3 μm. If too thick, irregularities on the device become too large, and the traveling of the microvolume liquid can be interrupted. If too thin, a resistance of both electrodes becomes large, and rising of an applied voltage can be delayed or a driving voltage can be increased by a voltage drop of the electrode itself.

It is also possible to transport an electrically insulating microvolume liquid such as ultrapure water by coating the surface of the second electrode with a hydrophobic dielectric film. In that case, a raw material for the dielectric film is optional. For example, SiO₂, Teflon (registered trademark), parylene or barium strontium titanate is used. A material higher in relative permittivity could make a required driving voltage smaller. A film thickness of the dielectric film is, for example, 0.1 to 2 μm. Although the microvolume liquid can be transported at lower voltage if the dielectric film is thinner, there is a possibility of electrolyzing the microvolume liquid when a voltage required for the transportation is applied. If the dielectric film is thickened, there is no concern of electrolyzing the microvolume liquid, but a voltage required for the transportation is increased. Therefore, for the thickness of a dielectric film, there exists such an appropriate value that does not electrolyze the microvolume liquid and is capable of transporting it at a voltage as low as possible. Further, if the dielectric film is thickened, irregularities on the device become large and thus there is a possibility that traveling of the microvolume liquid is interrupted.

The invention as set forth in claim 3 is the microvolume liquid dispensing device according to claim 2, wherein a plurality of the main channels are arranged in parallel with each other being spaced apart or the plurality of the main channels are independently arranged being spaced apart in such a manner that respective extensions are crossed but respective main channels are not connected with each other, respective downstream ends of the side channels provided to the main channels adjacent to each other are connected with each other, all of the connected side channels have the same volume ratio or different volume ratios, the second electrode is arranged at a connection portion at the downstream end of the side channel or slightly upstream of the connection portion of the side channel, the main channels transport different microvolume liquids, each microvolume liquid is sampled in a corresponding side channel during the transportation, and then the respective sampled different microvolume liquids are mixed at the same mixing ratio or different mixing ratios by voltage application between both electrodes.

According to the invention as set forth in claim 3, when different microvolume liquids are transported in respective main channels, each microvolume liquid is sampled in the side channel having the same volume ratio or different volume ratios among all of the connected side channels at the time of reaching the side channel since at least one surface of the side channel is hydrophilic. At that moment, downstream ends of the side channels provided to the main channels adjacent to each other are connected with each other, and the second electrode having a hydrophobic surface is provided at the connection portion or slightly upstream of the connection portion of each side channel. Thus, respective side channels of the main channels adjacent to each other are connected with each other but the different microvolume liquids within respective side channels are separated. After that, a voltage is applied between both electrodes, whereupon the respective sampled different microvolume liquids are attracted to the second electrode with a contact angle thereof smaller. As a result, those different microvolume liquids can be mixed at the same mixing ratio or different mixing ratios.

The number of side channels formed on each main channel may be two (two main channels are arranged in parallel) or three (three main channels are arranged in parallel). Further, adjacent main channels may be four or more (four main channels are arranged substantially annularly).

Side channels connected between the adjacent main channels preferably have the same total value in volume. Each volume ratio of respective connected side channels is optional.

Herein, the meaning of being different in volume ratio among the side channels will be described. For example, in the relationship between a plurality of side channels A1, A2 . . . An formed on one of main channels adjacent to each other and a plurality of side channels B1, B2 . . . Bn formed on the other main channel, corresponding side channels (for example, A1-B1, A2-B2 . . . An-Bn) shall be connected with each other. At that moment, a state where a ratio X1 of a volume of the side channel A1 to a volume of the side channel B1, a ratio X2 of a volume of the side channel A2 to a volume of the side channel B2 and a ratio Xn of a volume of the side channel An to a volume of the side channel Bn are different from one another is referred to as “being different in volume ratio among the side channels.”

The invention as set forth in claim 4 is the microvolume liquid dispensing device according to claim 1, wherein around an entrance of the side channel out of the one surface composed of the hydrophilic surface and hydrophobic surface of the main channel is made into a hydrophilic surface.

According to the invention as set forth in claim 4, around an entrance of the side channel out of the one surface of the main channel is made into a hydrophilic surface, so that the microvolume liquid being transported in the main channel is guided to the side channel with ease.

Being the hydrophilic surface may be only around an entrance of the side channel on one surface of the main channel or may be a side portion of the side channel including around the entrance.

The invention as set forth in claim 5 is the microvolume liquid dispensing device according to any one of claims 1 to 4, further including, on the substrate or cover, a nozzle penetrating through a surface of the side channel thereof and a surface opposed to the surface of the side channel, and having an end of an opening which is connected with the side channel.

Since the invention as set forth in claim 5 is provided with a nozzle having an end of an opening which is connected with the side channel, on the substrate or cover, the microvolume liquid within the side channel can be easily taken outside via the nozzle.

A part or the whole of an inner surface of the nozzle needs to be a hydrophilic surface. The reason for this is that the microvolume liquid in the side channel needs to be guided to a nozzle exit. Further, a nozzle end surface is preferably hydrophilic. This is because, if the nozzle end surface is hydrophilic, the microvolume liquid having been guided to the nozzle exit will stand up above the nozzle end surface, whereupon the microvolume liquid in the nozzle and, for example, a culture medium for biopsy cells will merge smoothly without entry of air when the nozzle end surface is soaked in the culture medium. The entire surface of an outer surface of the nozzle is preferably hydrophobic, because if a part of the nozzle outer surface is a hydrophilic surface, the microvolume liquid will travel through the hydrophilic surface and will flow out of the nozzle, and accordingly quantitative characteristics of the microvolume liquid will be impaired.

The nozzle may be formed on the substrate or on the cover. Further, the nozzle may be formed on both of the substrate and the cover.

The nozzle may be formed on the substrate or the cover in advance or may be added after the microvolume liquid dispensing device according to claims 1 to 4 is manufactured.

The nozzle has one end portion protruded from a surface opposed to the side channel, and the end portion is soaked into, for example, a culture medium for biopsy cells, thereby allowing an agent included in the microvolume liquid in the side channel to be transported by diffusion to the outside culture medium through the nozzle without depending on a negative pressure of an external sucking means. As a matter of course, the microvolume liquid in the side channel may be ejected outside through the nozzle with the use of a sucking means.

An inner diameter of the nozzle is about 10 to 500 μm. If the inner diameter is too large, guiding the microvolume liquid in the side channel to the nozzle exit by a capillary force will become difficult. If too small, it will take time to transport the agent in the microvolume liquid when the agent is diffused and transported through the nozzle, and a required sucking force will become large when the microvolume liquid itself is taken outside.

### EFFECTS OF THE INVENTION

According to the invention as set forth in claim 1 of the present invention, when the microvolume liquid being transported in the main channel reaches a branch portion with the side channel, a specific amount of the microvolume liquid can be sampled (measured) without requiring a tube connection with the outside of the device and only by introducing the microvolume liquid from the outside since at least one surface of the side channel is hydrophilic.

As a result, for example, in the drug discovery field of developing a new drug, the amount of a reagent used is reduced more remarkably than ever, and accordingly significant cost reductions can be achieved when an expensive reagent is used. Further, complicated connections between the device and its peripheral equipment other than the electrical connection become unnecessary, and required equipment is remarkably simplified. Therefore, the entire device becomes compact and inexpensive. This also leads to significant cost reductions.

In particular, according to the invention as set forth in claim 2, a first electrode is provided around a connection portion with the main channel in the side channel or at a position slightly apart from the connection portion, and a second electrode is provided at a downstream portion in the side channel, thereby allowing the microvolume liquid having been sampled in the side channel to be transported further within the device by electrical liquid operation.

Further, according to the invention as set forth in claim 3, a plurality of main channels are arranged being spaced apart, respective downstream ends of side channels provided to the main channels adjacent to each other are connected with each other, and herein all the connected side channels have the same volume ratio or different volume ratios. Therefore, electrical liquid operation with the use of the aforementioned first electrode and second electrode allows two or more kinds of microvolume liquids to be mixed at the same mixing ratio or different mixing ratios.

Furthermore, according to the invention as set forth in claim 4, around an entrance of the side channel on one surface of the main channel is made into a hydrophilic surface, so that the microvolume liquid being transported in the main channel is guided to the side channel with ease.

In the invention as set forth in claim 5, a nozzle having an end of an opening connected with the side channel is provided on the substrate or cover, and accordingly the microvolume liquid within the side channel can be easily taken outside via the nozzle.

### BRIEF DESCRIPTION OF THE DRAWINGS

FIG. 1a is a schematic plan view showing a sampling start state of a microvolume liquid by a microvolume liquid dispensing device according to a first embodiment of the present invention;

FIG. 1b is a schematic plan view showing a state during sampling the microvolume liquid by the microvolume liquid dispensing device according to the first embodiment of the present invention;

FIG. 1c is a schematic plan view showing a sampling completed state of the microvolume liquid by the microvolume liquid dispensing device according to the first embodiment of the present invention;

FIG. 1d is a schematic plan view showing a dispensing state of the microvolume liquid after the sampling by the microvolume liquid dispensing device according to the first embodiment of the present invention;

FIG. 2 is a longitudinal cross-sectional view orthogonal to a transporting direction of the microvolume liquid of the microvolume liquid dispensing device according to the first embodiment of the present invention;

FIG. 3 is a cross-sectional view taken along the line S3-S3 of FIG. 2;

FIG. 4a is a schematic plan view showing a sampling start state of microvolume liquids by a microvolume liquid dispensing device according to a second embodiment of the present invention;

FIG. 4b is a schematic plan view showing a sampling completed state of the microvolume liquids by the microvolume liquid dispensing device according to the second embodiment;

FIG. 4c is a schematic plan view showing a mixed state of the microvolume liquids after the sampling by the microvolume liquid dispensing device according to the second embodiment of the present invention;

FIG. 5 is a longitudinal cross-sectional view orthogonal to a transporting direction of the microvolume liquids of the microvolume liquid dispensing device according to the second embodiment of the present invention;

FIG. 6a is a schematic perspective view showing a sampling start state of microvolume liquids by a microvolume liquid dispensing device according to a third embodiment of the present invention;

FIG. 6b is a schematic perspective view showing a sampling completed state of the microvolume liquids by the microvolume liquid dispensing device according to the third embodiment of the present invention;

FIG. 6c is a schematic perspective view showing a mixed state of the microvolume liquids after the sampling by the microvolume liquid dispensing device according to the third embodiment of the present invention;

FIG. 6d is a schematic perspective view showing a cell seeding state into cell culture wells within a biopsy tray which is used being overlaid by the microvolume liquid dispensing device according to the third embodiment of the present invention;

FIG. 6e is a schematic perspective view showing a state where a biopsy of cells is in operation with the microvolume liquid dispensing device according to the third embodiment of the present invention and the cell culture wells overlaid; and

FIG. 6f is a schematic longitudinal cross-sectional view showing a state where the biopsy of cells is in operation with the microvolume liquid dispensing device according to the third embodiment of the present invention and the cell culture wells overlaid.

### DESCRIPTION OF SYMBOLS

10, 10A, 10B: Microvolume liquid dispensing device
11: Substrate
12: Cover
13: Main channel
14: Side channel
14a: Micro side channel
14b: Nozzle
15: First electrode
16: Second electrode
20: Micropipette
21: Biopsy tray
22: Cell culture well
23: Culture medium
24: Cell
A, B: Microvolume liquid
a: Hydrophilic surface
b: Hydrophobic surface
c: Hydrophobic thin film

### BEST MODES FOR CARRYING OUT THE INVENTION

Hereinafter, embodiments of the present invention will be described in detail.

### First Embodiment

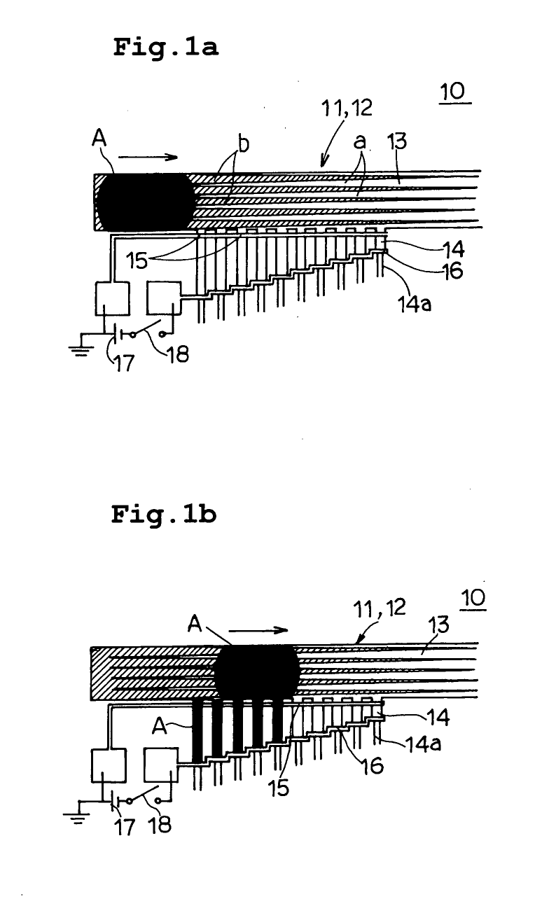

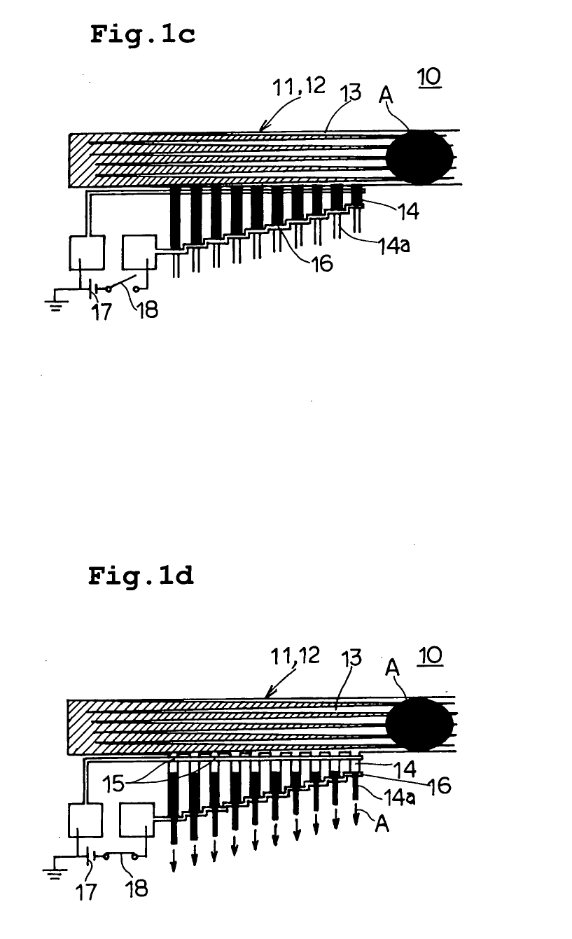

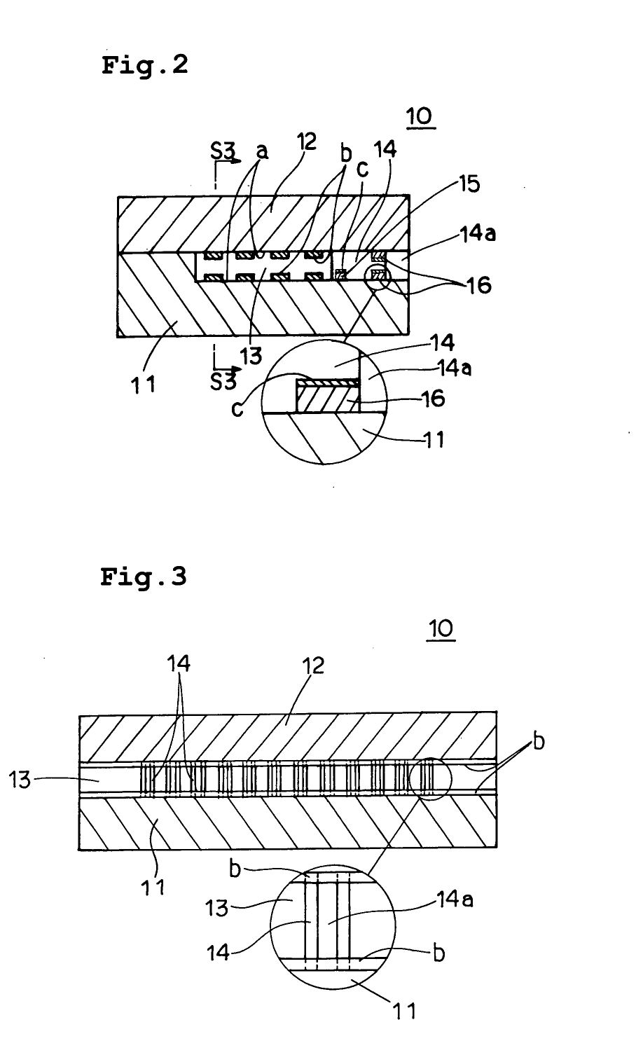

In FIGS. 1 to 3, reference numeral 10 is a microvolume liquid dispensing device according to a first embodiment of the present invention. The microvolume liquid dispensing device 10 includes a substrate 11, a cover 12 mounted on one surface of the substrate 11, a main channel 14 formed between the substrate 11 and the cover 12 and extending in one direction and a side channel 14 formed between the substrate 11 and the cover 12 and branched off from midway of the main channel 13. Hereinafter, those components will be described in detail.

As the substrate 11, adopted is a plastic (a cycloolefin polymer) substrate which is rectangular in a plan view and substantially concave-shaped in cross section. The substrate 11 has one main channel 13 and ten side channels 14. The substrate 11 has an opening side of the concave shape directed upward, and the cover 12 rectangular in a plan view is overlaid and mounted on the top surface of the substrate 11. A space rectangular in cross section between the concaved substrate 11 and the cover 12 constitutes the main channel 13 which transports a microvolume liquid A.

As the cover 12, adopted is a plastic (a cycloolefin polymer) substrate which is rectangular in a plan view. Dimensions of the substrate 11 are 30 mm in length, 30 mm in width and 1 mm in thickness. Dimensions of the cover 12 are 30 mm in length, 30 mm in width and 1 mm in thickness. The main channel 13 is formed over the entire or part length of the substrate 11. Respective side channels 14 are formed at a constant pitch in the longitudinal direction of the substrate 11 while the longitudinal direction thereof is oriented in the width direction of the substrate 11. A channel width of the main channel 13 is 2 mm and that of the side channel 14 is 500 μm. Micro side channels 14a narrowed up to 100 μm in channel width are connected with downstream ends of respective side channels 14. Each depth (channel height) of the main channel 13 and the side channels 14 (including the micro side channels 14a) is 25 μm.

On a top surface of the main channel 13 (a main channel portion on an undersurface of the cover 12) and a bottom surface of the main channel 13 (a main channel portion on a top surface of the substrate 11), formed is a wettability gradient surface which is continuously varied in value obtained by dividing an area of a hydrophilic surface “a” by that of a hydrophobic surface “b.” In addition, only either of the bottom surface or top surface of the main channel 13 may be made into the wettability gradient surface.

The hydrophobic surface is formed of a triangular pattern having a base of 50 μm to 500 μm and a height of 10 mm to 20 mm. Similarly, the hydrophilic surface is formed of a triangular pattern having a base of 50 μm to 500 μm and a height of 10 mm to 20 mm. Those triangular patterns are combined so as to alternate the hydrophilic surface “a” and the hydrophobic surface “b.” As shown in FIG. 1a, an upstream of the channel is formed so as to have a surface where an area of the hydrophobic surface “b” is larger than that of the hydrophilic surface “a,” and a downstream of the channel is formed so as to have a surface where an area of the hydrophilic surface “a” is larger than that of the hydrophobic surface “b.”

More specifically, the formation of the triangular patterns is carried out in such a manner that a value obtained by dividing an area of the hydrophilic surface “a” by that of the hydrophobic surface “b” is continuously increased from upstream toward downstream. As a material of the hydrophobic surface “b,” adopted is 1-octadecanethiol which is formed on a gold pattern. As a material of the hydrophilic surface “a,” adopted is SiO₂ (0.2 μm in thickness) formed on a plastic surface by sputtering. In addition, the microvolume liquid A being transported in the main channel 13 is guided to the side channel 14 with ease if a side portion at the side channel 14 on one surface of the main channel 13 is made into a hydrophilic surface. A pattern forming the hydrophilic surface “a” and the hydrophobic surface “b” is not restricted to the triangular pattern. For example, it may be configured such that sides except the base of the triangle are curved and a rate of change of the value obtained by dividing an area of the hydrophilic surface “a” by that of the hydrophobic surface “b” is non-linearly increased from upstream toward downstream.

On a top surface of the side channel 14 (a side channel portion on an undersurface of the cover 12) and a bottom surface of the side channel 14 (a side channel portion on a top surface of the substrate 11), formed is a hydrophilic surface “a.”

Further, in the vicinity of a side channel entrance portion (a branch portion) of only either one of the substrate 11 or the cover 12, serially formed is a first electrode 15 of gold over the entire width of each side channel 14. Further, at an end of the downstream side of the side channel 14 of both the substrate 11 and the cover 12, serially formed is a second electrode 16 of gold over the entire width of each side channel 14. On a surface of the first electrode 15 and second electrode 16, a thin film “c” of 1-octadecanethiol exhibiting hydrophobic property is formed.

The surface of the first electrode 15 is hydrophobic but a surface of the side channel opposed thereto is hydrophilic. Thus, the microvolume liquid A having been guided to the side channel cannot stay on the first electrode 15.

The surface of the second electrode 16 is hydrophobic and is formed on all inner wall surfaces constituting the side channel. Thus, the microvolume liquid A having been guided to the side channel is dammed on an end surface of the upstream side of the second electrode 16. As a result, the microvolume liquid A determined by a volume sandwiched between the side channel entrance and the end of the second electrode 16 is measured. The microvolume liquid A is an electrolytic solution containing ions. Each first electrode 15 is electrically connected by a wire and each second electrode 16 is electrically connected by another wire. They constitute an electric circuit with a power source (approximately 3V) 17 and a switch 18 arranged midway.

Hereinafter, a manufacturing method of the substrate 11 will be described. First, the substrate 11 having a main channel 13 and side channels 14 of 25 μm in depth is injection molded with a cycloolefin polymer. Subsequently, an SiO₂ thin film is formed on a bottom surface of all of the channels by a sputtering method and a lift-off method. More specifically, a resist is left on the entire surface except the channel by negative resist application, ultraviolet exposure and development. An opening portion is provided only on a bottom surface portion of the channel, and on the entire surface thereof, an SiO₂ thin film is formed by a sputtering method. Then, the SiO₂ thin film on the resist is removed by resist removal with acetone. As a result, the SiO₂ thin film can be formed only on the bottom surface of the channel.

After that, a gold thin film triangular pattern is formed on the SiO₂ thin film of the main channel 13 by a vacuum evaporation method and a lift-off method. At the same time, gold thin films of the electrode 15 and electrode 16 are patterned so as to cross the side channels 14. More specifically, the following operation is performed. A resist is left on the entire surface except places where the triangular pattern and both electrodes are formed, by negative resist application, ultraviolet exposure and development, and opening portions are provided only at the places where the triangular pattern and both electrodes are formed. On the entire surface thereof, a gold thin film is formed by a vacuum evaporation method, and then the gold thin film on the resist is removed by resist removal with acetone. As a result, the gold thin film triangular pattern on the main channel 13 and the electrode 15 and electrode 16 crossing the side channels 14 can be formed.

1-octadecanethiol is formed on the gold thin film as a hydrophobic surface “b” by a dipping method, whereby the SiO₂ thin film having been exposed on the bottom surface of the main channel 13 acts as a hydrophilic surface “a.” By this way, the substrate 11 formed with a concaved structure in cross section and having the electrodes 15 and 16 is manufactured.

On the other hand, on the plastic substrate of the cover 12, an SiO₂ thin film is formed at a place corresponding to a top surface of all of the channels by a sputtering method and a lift-off method. After that, a gold thin film triangular pattern is formed on the SiO₂ thin film corresponding to the main channel 13 by a vacuum evaporation method and a lift-off method. At the same time, a gold thin film for the electrode 16 is patterned so as to cross a place corresponding to the side channel 14. At that moment, attention is required to not form a gold thin film for the electrode 15. Subsequently, a monolayer of 1-octadecanethiol is self-assemblingly formed on the gold thin film by a dipping method. The substrate 11 and cover 12 thus obtained are adhered to each other by thermal compression bonding.

Now, usage of the microvolume liquid dispensing device 10 according to the first embodiment of the present invention will be described with reference to FIGS. 1a to 1d.

0.4 to 1 μL of a microvolume liquid A is measured by a general-purpose dispenser, and the microvolume liquid A is introduced from the upstream of the main channel 13 into the device (FIG. 1a). The top surface and bottom surface of the main channel 13 continuously change from upstream toward downstream in wettability from a surface high in hydrophobic property to a surface high in hydrophilic property. Therefore, the microvolume liquid A automatically starts its travel within the main channel 13. Here, if the side surface of the main channel 13 is hydrophilic, the microvolume liquid A tries to stay on the surface. Therefore, smooth liquid delivery becomes difficult. However, the plastic substrate surface exhibiting hydrophobic property is adopted as a material for the side surface of the channel, and accordingly such a problem does not arise.

While the microvolume liquid A travels in the main channel 13, a part of the microvolume liquid A is guided to each side channel 14 by a capillary force (FIG. 1b). The guided microvolume liquid A is dammed at an end of the second electrode 16 midway of each side channel 14. The microvolume liquid A which has not been guided to the side channels 14 continues traveling downstream of the main channel 13. As a result, a specific amount of the microvolume liquid A determined by a volume sandwiched between a side channel entrance and the second electrode 16 is measured out (FIG. 1c). Herein, there are constructed ten side channels 14 with volumes increased toward the downstream at a specific ratio, whereby ten pieces of the microvolume liquid A different in liquid amount can be sampled (measured).

Subsequently, the switch 18 is turned on to apply a voltage of approximately 3V between the first electrode 15 and the second electrode 16 provided midway of each side channel 14. By this, the electrode 16 contacting with the front end of the microvolume liquid A attracts the microvolume liquid A, so that a contact angle of the microvolume liquid A becomes small. That is, apparent surface wettability of the electrode 16 turns from hydrophobic property to hydrophilic property. Thus, the microvolume liquid A gets on the surface of the second electrode 16 and gets over the second electrode 16 eventually. A specific amount of the microvolume liquid A is further transported in the side channel 14 (FIG. 1d). Since a micro side channel 14a smaller than the side channel 14 in cross sectional area is connected with the downstream side of the second electrode 16, the capillary force of carrying the microvolume liquid A downstream is larger than the side channel 14, and accordingly the microvolume liquid A is delivered without fail.

As above, when the microvolume liquid A being transported in the main channel 13 reaches a branch portion with each side channel 14, a specific amount of the microvolume liquid A can be sampled without requiring a tube connection with the outside of the device and only by introducing the microvolume liquid A from the outside, since at least one surface of each side channel 14 is hydrophilic. As a result, in the drug discovery field of developing a new drug, for example, an amount of a reagent used is reduced more remarkably than ever, and accordingly significant cost reductions can be promoted when an expensive reagent is used. Furthermore, complicated connections between the device and its peripheral equipment other than the electric connection become unnecessary, and required peripheral equipment is remarkably simplified. As a result, the entire device becomes compact and inexpensive. This also leads to significant cost reductions.

Further, the other surface as well as one surface of the main channel 13 is also composed of a hydrophilic surface “a” and a hydrophobic surface “b,” and a value obtained by dividing an area of the hydrophilic surface “a” by that of the hydrophobic surface “b” is configured to be increased continuously from upstream toward downstream of the other surface. Therefore, transportability of the microvolume liquid A in the main channel 13 is enhanced.

### Second Embodiment

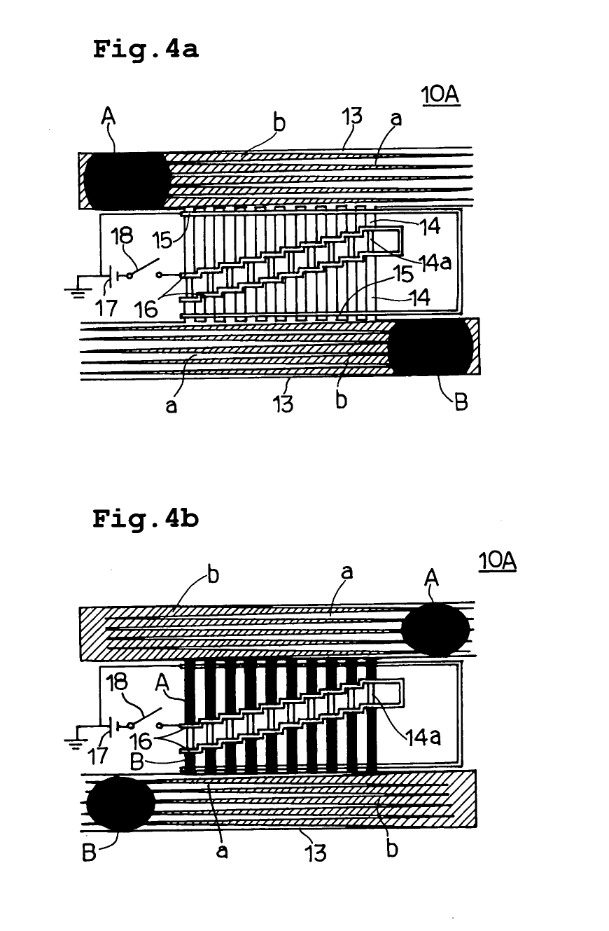

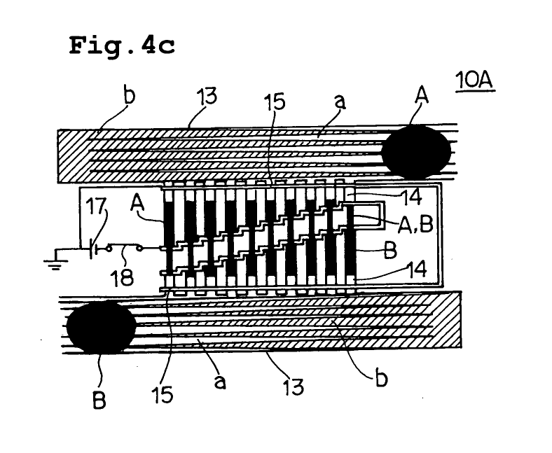

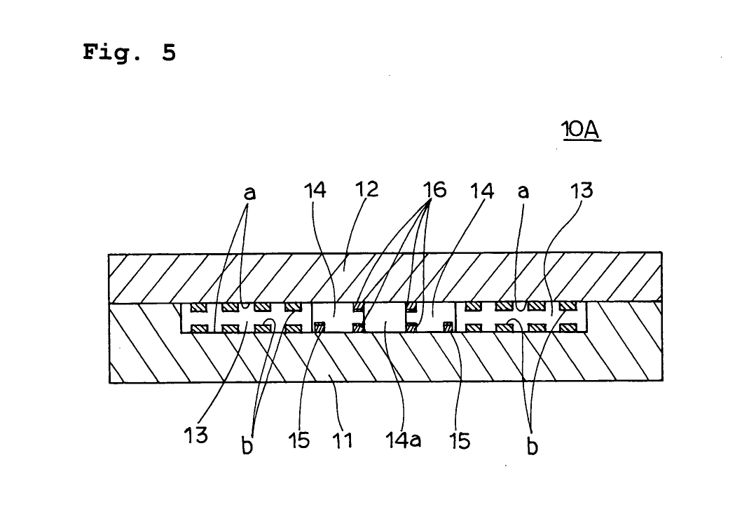

Next, a microvolume liquid dispensing device 10A according to a second embodiment of the present invention will be described with reference to FIG. 4 and FIG. 5.

As shown in FIG. 4 and FIG. 5, the microvolume liquid dispensing device 10A of the second embodiment is such that two main channels 13 are arranged in parallel with each other being spaced apart, downstream ends of respective ten side channels 14 of the adjacent main channels 13 are connected with each other by micro side channels 14a, a second electrode 16 is arranged at a connection portion at a downstream end of each side channel 14, different microvolume liquids A and B are transported in the main channels 13, each microvolume liquid A, B is sampled in each side channel 14 during the transportation, and then the sampled different microvolume liquids A and B are mixed by voltage application between a corresponding first electrode 15 and second electrode 16. The microvolume liquid A is the above-mentioned electrolytic solution containing ions while the microvolume liquid B is another electrolytic solution containing ions.

In this case, the two main channels 13 have the same shape, and the side channels 14 connected with each other between both main channels 13 are all configured to have the same total value in volume but are different in volume ratio. More specifically, transporting directions of the microvolume liquids A and B in both main channels 13 are opposed. Thus, to a side channel 14 having the largest volume of one of the main channels 13, a side channel 14 having the smallest volume of the other main channel 13 is connected. Aside channel 14 having the second largest volume of the one main channel 13 and a side channel 14 having the second smallest volume of the other main channel 13 are connected in sequence. The first electrode 15 of each side channel 14 of both main channels 13 is electrically connected by a wire. The second electrode 16 of each side channel 14 of both main channels 13 is electrically connected by another wire.

Next, usage of the microvolume liquid dispensing device 10A according to the second embodiment of the present invention will be described with reference to FIGS. 4a to 4c.

0.4 to 1 μL of a microvolume liquid A and a microvolume liquid B are measured by a general-purpose dispenser and introduced from the upstream of the two main channels 13 (FIG. 4a). The microvolume liquids A and B automatically travel toward the downstream in the main channels 13 due to a wettability gradient, and a part thereof is guided to the side channel 14 midway. The guided liquid is dammed at an end of the second electrode 16 midway of the side channel 14, and specific amounts of the microvolume liquids A and B are measured out (FIG. 4b). Subsequently, a voltage is applied to both electrodes 15 and 16 provided midway of the side channel 14. Then, the measured microvolume liquids A and B within the side channels 14 get over the second electrodes 16, come in contact with each other and are mixed eventually (FIG. 4c). Changing the length of a plurality of side channels 14 allows for mixing at various mixing ratios. Further, since volumes of the liquids A and B are significantly small, the mixing progresses rapidly and a time required is remarkably short.

Since the microvolume liquid dispensing device 10A of the second embodiment is configured as above, different microvolume liquids A and B are sampled in corresponding side channels 14 during transporting the microvolume liquids A and B in the main channels 13, and then each sampled different microvolume liquid A, B can be mixed in respective side channels 14 by voltage application to both electrodes 15 and 16. Moreover, in the second embodiment, the side channels 14 connected with each other between both main channels 13 are all configured to have the same total value in volume but are different in volume ratio, so that the respective sampled microvolume liquids A and B can be mixed at different mixing ratios.

### Third Embodiment

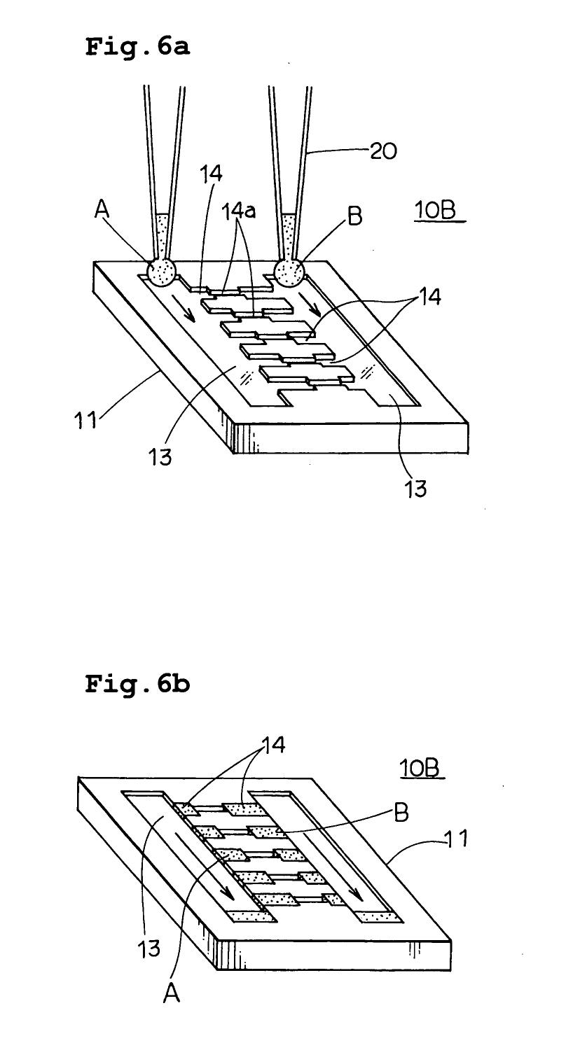

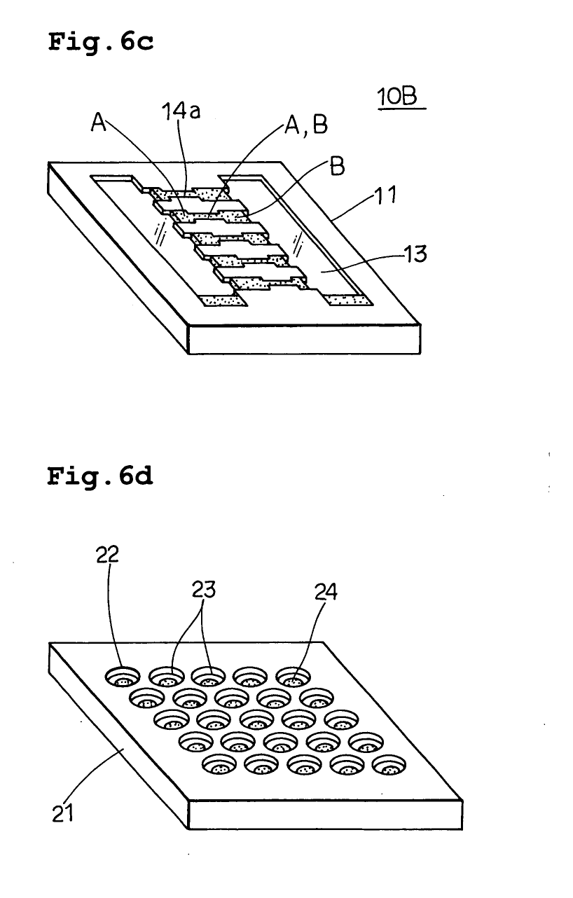

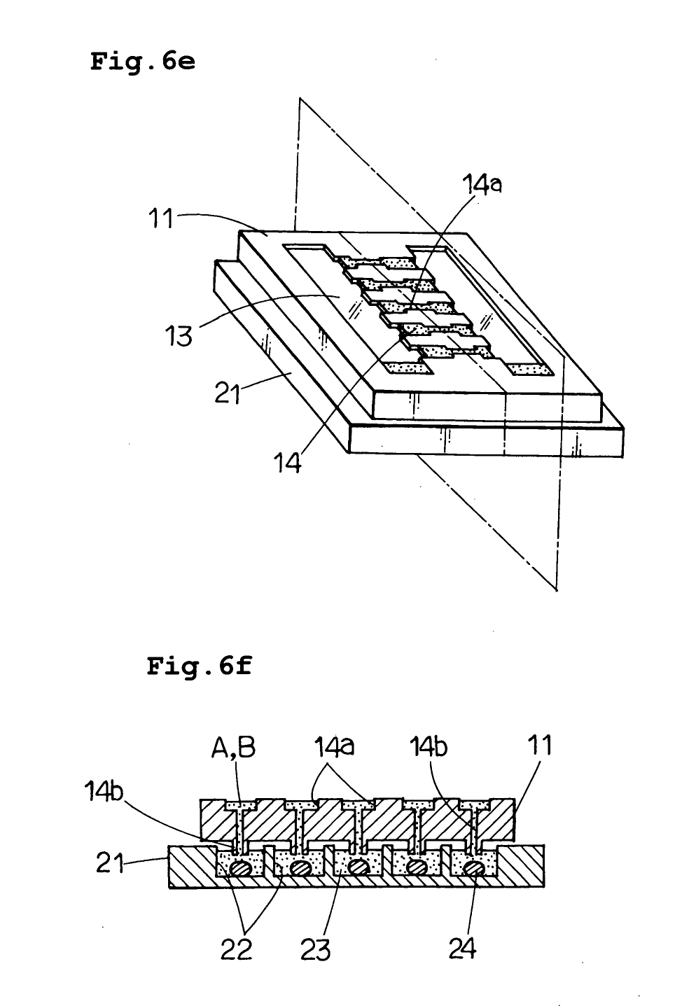

Next, a microvolume liquid dispensing device 10B according to a third embodiment of the present invention will be described with reference to FIG. 6.

As shown in FIG. 6, the microvolume liquid dispensing device 10B of the third embodiment is changed in the following points of the configuration of the microvolume liquid dispensing device 10A of the second embodiment.

They are (1) that the transporting directions of the microvolume liquids A and B in both main channels 13 are the same, (2) that the number of side channels 14 connected with each main channel 13 is five, and (3) that five nozzles 14b in total, each having one end of an opening that is connected with the side channel 14, are arranged on the intermediate portion in the longitudinal direction of respective micro side channels 14a on the substrate 11 (FIG. 6f). In one of the main channels 13, volumes of the side channels 14 become gradually smaller toward downstream while in the other main channel 13, volumes of the side channels 14 become gradually larger toward downstream. Each nozzle 14b has an inner diameter of 50 μm, and a distal end portion thereof protrudes 2 mm downward from the undersurface of the substrate 11.

Next, usage of the microvolume liquid dispensing device 10B according to the third embodiment will be described with reference to FIGS. 6a to 6f.

1 μL of a microvolume liquid A and a microvolume liquid B are measured by a micropipette 20 and introduced to the upstream of the two main channels 13 (FIG. 6a).

Those microvolume liquids A and B automatically travel downstream in respective main channels 13 due to a wettability gradient, and a part thereof is guided to each side channel 14 midway. The guided microvolume liquids A and B are dammed at an end of second electrodes 16 midway of corresponding side channels 14, and specific amounts of them are measured out (FIG. 6b).

Subsequently, a voltage is applied to both electrodes 15 and 16 provided midway of each side channel 14, so that the measured microvolume liquids A and B in respective side channels 14 get over the second electrodes 16 and travel, come in contact with each other and are mixed eventually (FIG. 6c).

On the other hand, a biopsy tray 21 formed with 5 by 5 (25 in total) cell culture wells (pockets) 22 on a top surface thereof is prepared. In each cell culture well 22, a cell 24 which is an analyte and a culture medium 23 therefor are injected=(FIG. 6d).

After that, the substrate 11 is placed on the biopsy tray 21, and respective distal end portions of the nozzles 14b are soaked into the culture mediums 23 in the cell culture wells 22 (respective openings at a distal end are placed under the liquid level) in a predetermined line (row). As a result, an agent included in the liquid mixture of the microvolume liquids A and B in each micro side channel 14a located above is transported by diffusion into the culture medium 23 in the cell culture well 22 located below via each nozzle 14b. Accordingly, a biopsy of respective cells 24 can be performed with the use of the microvolume liquids A and B mixed at five different mixing ratios.

As above, the nozzle 14b is arranged at a portion of each micro side channel 14a on the substrate 11, so that a component such as an agent included in the microvolume liquids A and B within each micro side channel 14a can be extracted outside easily. Moreover, the distal end portion of each nozzle 14b is configured to protrude from the undersurface of the substrate 11 and be soaked into the culture solution 23 in the cell culture well 22. Consequently, a component such as an agent included in the microvolume liquids A and B within each micro side channel 14a can automatically be transported by diffusion into a culture medium 23 in a corresponding cell culture well 22 even without using external force such as pressure, gravity and acoustic wave.

Other configurations, operation and effects are within the assumable range from the second embodiment, and thus their descriptions are omitted.

### INDUSTRIAL APPLICABILITY

The present invention can be used in the field of chemical analysis and biochemical analysis. More specifically, the present invention is applicable to compact medical analyzers, portable environmental analyzers, etc. Its effects are such that an analysis time is reduced due to rapid reaction on a microscale, thereby allowing for on-site analyses, and also that an amount of reagent and sample (test specimen) used is reduced, thereby being able to promote reduction in running costs, downsizing of liquid delivery systems such as liquid delivery channels, significant reduction in waste liquid amount and resulting mitigation of environmental contamination.

Further, the present invention can be used in the field of chemical synthesis. More specifically, the present invention is applicable to high-efficiency chemical plants, on-demand manufacturing systems, etc. Its effects are such that flow processing becomes possible due to rapid reaction on a microscale, and also that precise reaction control is possible due to high homogeneity of a temperature/concentration field, and in a case of a microreactor, a time period from development to production can be significantly reduced due to ease of design and manufacturing, thereupon being able to promote yield improvement by high-efficiency reaction.

Further, the present invention is suitable for drug discovery screening (exhaustive searching). In other words, the present invention is superior in searching an optimum concentration of one agent and searching an optimum mixing ratio of two agents (searching a new drug based on new effects).

1. A microvolume liquid dispensing device comprising:
a substrate;
a cover mounted on one surface of the substrate;
a main channel formed between the substrate and the cover and extending substantially linearly; and
one or a plurality of side channels formed between the substrate and the cover, branched off from midway of the main channel and extending substantially linearly, wherein
at least one surface of inner wall surfaces constituting the main channel is composed of a hydrophilic surface and a hydrophobic surface, and a value obtained by dividing an area of the hydrophilic surface by that of the hydrophobic surface is continuously increased from upstream toward downstream thereof, thereby transporting a microvolume liquid; and
at least one surface of inner wall surfaces constituting the side channel is made hydrophilic, and a part of the microvolume liquid is guided to the side channel while the microvolume liquid is being transported in the main channel, thereby sampling a predetermined amount of the microvolume liquid.

2. The microvolume liquid dispensing device according to claim 1, wherein
the substrate and the cover possess electrical insulation;
at least one surface of the inner wall surfaces constituting the side channel is provided with a first electrode and a second electrode in this order toward downstream thereof being spaced apart;
a surface of the second electrode is hydrophobic;
a microvolume liquid having been dammed at an end of the second electrode having the hydrophobic surface is conveyed downstream of the side channel by applying a voltage between both electrodes.

3. The microvolume liquid dispensing device according to claim 2, wherein
a plurality of the main channels are arranged in parallel with each other being spaced apart, or the plurality of the main channels are independently arranged being spaced apart in such a manner that respective extensions are crossed but respective main channels are not connected with each other;
respective downstream ends of the side channels provided to the main channels adjacent to each other are connected with each other;
all of the connected side channels have the same volume ratio or different volume ratios;
the second electrode is arranged at a connection portion at the downstream end of each side channel or slightly upstream of the connection portion of the side channel; and
the main channels transport different microvolume liquids respectively, each microvolume liquid is sampled in a corresponding side channel during the transportation, and then the respective sampled different microvolume liquids are mixed at the same mixing ratio or different mixing ratios by voltage application between both electrodes.

4. The microvolume liquid dispensing device according to claim 1, wherein around an entrance of the side channel out of the one surface composed of the hydrophilic surface and the hydrophobic surface of the main channel is made into a hydrophilic surface.

5. The microvolume liquid dispensing device according to any one of claims 1 to 4, further comprising, on the substrate or cover, a nozzle penetrating through a surface of the side channel of thereof and a surface opposed to the surface of the side channel, and having an end of an opening which is connected with the side channel.
